(19) United States
(12) Patent Application Publication
(10) Pub. No.: US 2009/0249622 A1
(43) Pub. Date: Oct. 8, 2009

(54) Method for the manufacture of integrally bladed rotors

(76) Inventor: Karl Schreiber, Am Mellensee (DE)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/385,374

(22) Filed: Apr. 6, 2009

(30) Foreign Application Priority Data
Apr. 4, 2008 (DE) DE102008017495.5

(51) Int. Cl. B23P 15/04; B23K 9/00

(52) U.S. Cl. 29/889; 219/137 R

(57) ABSTRACT

The manufacture or repair of blisks, in particular high-pressure turbine blisks for gas-turbine engines is accomplished by producing a joint between the rotor disk and the pre-manufactured blades by circular friction welding. Due to the small forces and the low acceleration required for heat generation by friction and the balanced circular movement during frictional welding at a constant setting angle between disk and rotor, exact and uniform arrangement and alignment of the blades on the periphery of the rotor disk are possible even with small and complex joining surfaces of the turbine blades and with dissimilar materials.

This application claims priority to German Patent Application DE102008017495.5 filed Apr. 4, 2008, the entirety of which is incorporated by reference herein.

The present invention relates to a method for the manufacture or repair of integrally bladed rotors, in particular high-pressure turbine blisks for gas-turbine engines, in which a multitude of pre-manufactured blades is formed onto the periphery of a rotor disk in a joining process.

Integrally bladed rotors used in engine manufacture, which are also termed “blisks”, are characterized by reduced assembly costs, considerable weight saving, increased mechanical loadability as well as optimum flow guidance and high efficiency, as compared to conventional rotors with blades detachably mounted on a rotor disk. As is generally known, blisk-type rotors are manufactured by milling from the solid material. Also proposed was joining of pre-manufactured blades to the rotor disk by linear friction welding. Although milling of the blades from the solid material of a disk blank is independent of size and design, it requires high work and material investment.

The manufacture of blisks by linear friction welding, as described for example in U.S. Pat. No. 6,219,916 or EP 1535692, is restricted to a certain component design and to large-size blades and, moreover, requires a complex fixture concept. In the manufacture of blisks by linear friction welding, the high forces to be transmitted and the high acceleration during oscillation as well as the precise alignment of the components to be joined involves considerable difficulties, in particular with small turbine blades provided with cooling air supply ducts and correspondingly small, complexly shaped joining surfaces, especially when the different mechanical and thermal loading calls for the use of dissimilar materials for the rotor disk and the blades. The great advantages of blisks have, however, aroused a strong, yet unsatisfied desire to employ integral blading also on the rotors of high-pressure turbines, which preferably are made of dissimilar disk and blade materials.

In the method described in DE 10 2006 033 298 A1, blade airfoil elements with a certain finish-machining allowance are joined by friction twist welding to a rotor disk having formed-on blade roots, with the blades being subsequently finish-machined by cutting or electrochemically. The method described in DE 10 2004 032 461 A1 for producing a weld joint between the rotor disk and the pre-manufactured blades requires a locating strip formed on the airfoil for maintaining the welding gap and fixing the blade airfoil as well as a subsequent cutting and machining operation. The use of these welding processes for blisk manufacture incurs considerable work effort and has been omitted so far for the manufacture of bladed rotors in the field of turbines. A further problem in the manufacture of blisks by linear friction welding is the requirement for rework due to bulging during welding and for highly investive balancing due to inaccurate blade alignment resulting from imbalance of the linear movement.

A broad aspect of the present invention is provide a method for the manufacture of integrally bladed engine rotors which enables the disk and the blades to be firmly joined and the blades to be precisely arranged and aligned even with small blades, where correspondingly small joining surfaces are involved, and with dissimilar materials being used for rotor disk and blades.

In essence the present invention involves a circular friction welding movement performed by the joining surfaces moving on each other to integrally assemble the blades with a rotor disk. The circular movement may be performed either by the blade and the disk, with the two joining surfaces circularly moving on each other, offset by 180°, or the circular movement can preferably be performed by the blade only, enabling the apparatus investment to be considerably reduced. Surprisingly it was found that this friction welding process is capable of producing integrally bladed high-pressure turbine rotors which have complex blade cross-sections and whose disk and blades are subject to very different mechanical and thermal loads and are made of correspondingly dissimilar materials. When producing the weld joint by circular movement of both components, the setting angle of the blade relative to the disk is not changed throughout the entire welding process and can, therefore, be set identical for each blade. Since acceleration and force impact are controllable and imbalance is avoided by the circular movement during the heating and welding process, the blades can be precisely arranged and uniformly aligned on the rotor disk in a small space, thereby minimizing rotor imbalance.

The present invention is more fully described by way of an example for the manufacture of a high-pressure turbine blisk.

While the rotor disk of a high-pressure turbine blisk, which is subjected to a temperature of approx. 650° C., is made of Udimet® 720, i.e. a nickel-base alloy of extremely high strength, the turbine blades to be joined to the rotor disk, which have cooling-air holes and correspondingly small cross-section and are exposed to a temperature of approx. 1200° C., are made of the single-crystal alloy CMSX®-4, i.e. a high temperature-resistant nickel-base alloy. Of course, other material combinations can also be used to meet the different mechanical and thermal loads. For example, the blades may also be made of directionally solidified or polycrystalline materials.

The joint between rotor disk and blade is made by friction welding on the basis of a circular movement of the rotor disk and the blade, i.e. the both joining surfaces moving with respect to each other. Here, the rotor disk and the blade to be joined to it are each clamped into a vibratory fixture and, with their opposite joining surfaces, which contact each other, co-directionally set in minute, circular movements with a phase offset of 180°. The concentrically arranged machine system is balanced by means of weights, resulting in minimum external forces. The 180° offset, co-directional relative movement of the two components or joining surfaces, respectively, and the areal friction thus produced will uniformly and rapidly heat the material of blade and disk in the joining plane. As soon as the joining temperature is reached and the two materials are in plastic state, the circular movement of the two parts is stopped by moving them to a common rotary center and a pressure is exerted on both parts in the direction of the joining surface, thereby welding the respective blade to the rotor disk. Throughout the entire heating and joining process, the setting angle of the blade to the rotor disk remains unchanged. Owing to the rapid and uniform heating obtained in the joining area by the circular movement of the two joining surfaces, only a small force is required even for joining very dissimilar materials, enabling blades with very small and complexly shaped cross-sectional areas to be firmly joined to the rotor disk and the blades to be precisely set relative to the rotor disk so that essentially no imbalance of a blisk so produced is noted.

The method described above can also be used for the repair of the high-pressure turbine blisk, with the new airfoil element being joined to a blade stub remaining on the rotor disk after cutting off the damaged turbine blade. In particular, the circular movement may also be performed by the blade only.

What is claimed is:

1. A method for attaching a blade to a rotor disk, comprising:
connecting a joining surface of the blade by circular friction welding to a joining surface on at least one of a periphery of the rotor disk and a blade stub of the rotor disk, the circular friction welding including:
bringing the blade joining surface into contact with the joining surface of the at least one of the rotor disk and the blade stub;
circularly moving at least one of the blade and the rotor disk with respect to the other to heat both of the respective joining surfaces to a plastic state while maintaining a constant alignment of the blade to the rotor disk; and
pressing the respective joining surfaces into each other at a desired alignment and positioning while both joining surfaces are in the plastic state to weld the blade to the rotor disk.

2. The method of claim 1, wherein the joining surface of the blade is moved and the joining surface of the rotor disk is held at rest during the circular movement of at least one of the blade and the rotor disk with respect to the other.

3. The method of claim 1, wherein the joining surface of the rotor disk is moved and the joining surface of the blade is held at rest during the circular movement of at least one of the blade and the rotor disk with respect to the other.

4. The method of claim 1, wherein the joining surfaces of each of the blade and the rotor disk are moved in a co-directional, offset, circular, frictional movement during the circular movement of at least one of the blade and the rotor disk with respect to the other.

5. The method of claim 4, wherein the blade and the rotor disk being welded together are constructed from at least one of dissimilar materials with different mechanical and thermal loadability and same materials with different microstructures.

6. The method of claim 5, wherein the welding of the blade to the rotor disk also connects cooling air ducts in each of the blade and the rotor disk.

7. The method of claim 1, wherein the blade and the rotor disk being welded together are constructed from at least one of dissimilar materials with different mechanical and thermal loadability and same materials with different microstructures.

8. The method of claim 7, wherein the welding of the blade to the rotor disk also connects cooling air ducts in each of the blade and the rotor disk.

9. The method of claim 2, wherein the blade and the rotor disk being welded together are constructed from at least one of dissimilar materials with different mechanical and thermal loadability and same materials with different microstructures.

10. The method of claim 9, wherein the welding of the blade to the rotor disk also connects cooling air ducts in each of the blade and the rotor disk.

11. The method of claim 3, wherein the blade and the rotor disk being welded together are constructed from at least one of dissimilar materials with different mechanical and thermal loadability and same materials with different microstructures.

12. The method of claim 11, wherein the welding of the blade to the rotor disk also connects cooling air ducts in each of the blade and the rotor disk.

13. The method of claim 1, wherein the welding of the blade to the rotor disk also connects cooling air ducts in each of the blade and the rotor disk.

14. The method of claim 2, wherein the welding of the blade to the rotor disk also connects cooling air ducts in each of the blade and the rotor disk.

15. The method of claim 3, wherein the welding of the blade to the rotor disk also connects cooling air ducts in each of the blade and the rotor disk.

16. The method of claim 4, wherein the welding of the blade to the rotor disk also connects cooling air ducts in each of the blade and the rotor disk.
